(19) United States
(12) Patent Application Publication
(10) Pub. No.: US 2016/0226362 A1
(43) Pub. Date: Aug. 4, 2016

(54) Flat Linear Vibration Motor

(71) Applicants: Hongxing Wang, Shenzhen (CN); Lubin Mao, Shenzhen (CN); Shun Guo, Shenzhen (CN)

(72) Inventors: Hongxing Wang, Shenzhen (CN); Lubin Mao, Shenzhen (CN); Shun Guo, Shenzhen (CN)

(73) Assignee: AAC Technologies Pte. Ltd., Singapore City (SG)

(21) Appl. No.: 15/011,489

(22) Filed: Jan. 30, 2016

(30) Foreign Application Priority Data
Feb. 2, 2015 (CN) 201510054384.X

(51) Int. Cl. H02K 33/00

(52) U.S. Cl. CPC H02K 33/00

(57) ABSTRACT

A flat linear vibration motor is disclosed. The flat linear vibration motor includes a housing having an accommodation space; a first magnet received in the accommodation space and fixed in the housing; and a vibrator unit suspended in the housing. The vibrator unit includes a clump weight, a third magnet, a driving magnet, and a fourth magnet; a second magnet fixed in the housing, the first magnet, the vibrator unit and the second magnet arranged one by one along a vibration direction of the vibrator unit; engaging assemblies suspending the vibrator unit inside the housing and driving the vibrator unit to move along the vibration direction; wherein the flat linear vibration motor further includes a ring driving coil received in the accommodation space, the ring driving coil being spaced from and surrounding the driving magnet.

### FIELD OF THE INVENTION

This invention relates to a type of vibration motor, especially a type of flat linear vibration motor which is used for those portable consumption electronic products.

### DESCRIPTION OF RELATED ART

With the development of electronic technology, portable consumption electronic products become more and more popular, such as cellphones, handheld game player, navigation device, or handheld multimedia recreation equipment, etc., vibration motor is usually used on these electronic products to make system feedback, such as cellphones call reminders, SMS tips, navigation tips, and vibration feedback of game players, etc. Such wide application requires that the vibration motor must be of high performance and long service life.

The vibration motor of related technology includes a housing, a vibrator unit received in the housing and a spring unit used to suspend the vibrator unit within the housing and provide restoring force and localization guidance to the vibrator unit. But the vibrator unit of the vibration motor with this kind of structure shakes easily and spring will be failed and worn elastically due to long-term use, so the performance and service life of motor will be influenced. In addition, the driving coils of the vibration motor with this kind of structure are provided on one side face of vibrator unit. This kind of assembly mode makes the insufficient electromagnetic driver force generated by driving coil.

Therefore, it is necessary to provide a new flat linear vibration motor to solve the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and exploded view of a flat linear vibration motor in accordance with an exemplary embodiment of the present disclosure.

FIG. 2 is a cross-sectional view of the flat linear vibration motor in FIG. 1 taken along a longer axis thereof.

FIG. 3 is a partial assembled view of the flat linear vibration motor shown in FIG. 1.

FIG. 4 is a first cross-sectional view of the flat linear vibration motor shown in FIG. 1 taken along a shorter axis.

FIG. 5 is a second cross-sectional view of the flat linear vibration motor shown in FIG. 1, taken along the shorter axis.

### DETAILED DESCRIPTION OF THE EXEMPLARY EMBODIMENT

The present invention will hereinafter be described in detail with reference to an exemplary embodiment. It should be understood the specific embodiments described hereby is only to explain this disclosure, not intended to limit this disclosure.

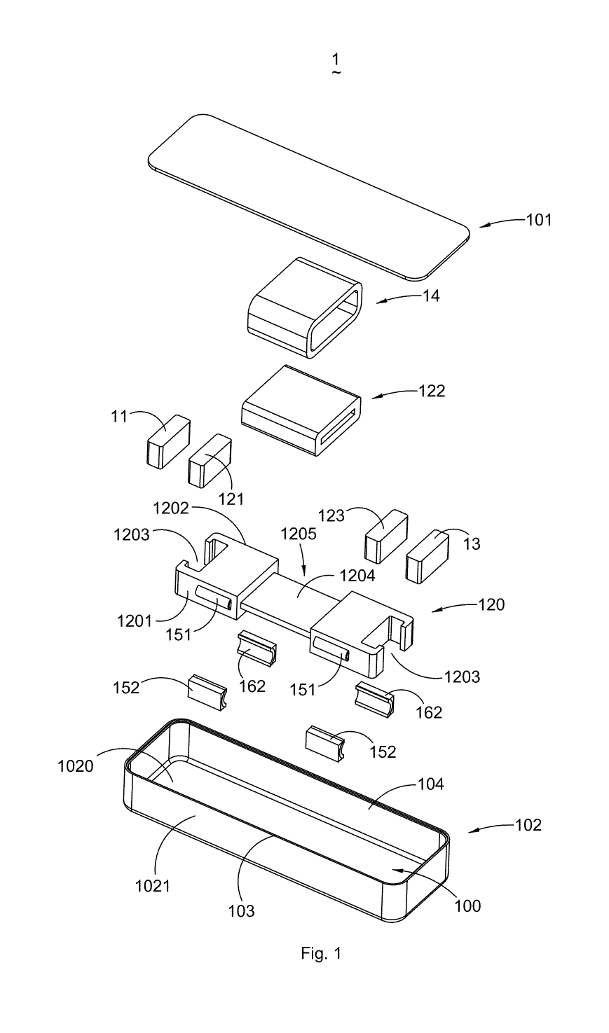

As shown in FIGS. 1-3, a flat linear vibration motor 1 in accordance with an exemplary embodiment of the present disclosure includes a housing 10 forming an accommodation space 100, a first magnet 11 received in the accommodation space 100 and fixed in the housing 10, a vibrator unit 12 suspended in the housing 10 and a second magnet 13 fixed in the housing 10. The first magnet 11, the vibrator unit 12 and the second magnet 13 are arranged one by one along a vibration direction X-X of the vibrator unit 12.

The housing 10 includes an upper shell 101 and a lower shell 102 cooperating with the upper shell 101 to form the accommodation space 100. The lower shell 102 includes a bottom wall 1020 and a side wall 1021 extending from the bottom wall 1020. The first magnet 11 and the second magnet 13 are fixed respectively in the side wall 1021 of the lower shell 102 and disposed in an inner side face of the side wall 1021. The upper shell 101 can be plate-shaped or the same shape as that of following lower shell 102. Various shapes can be set according to concrete need.

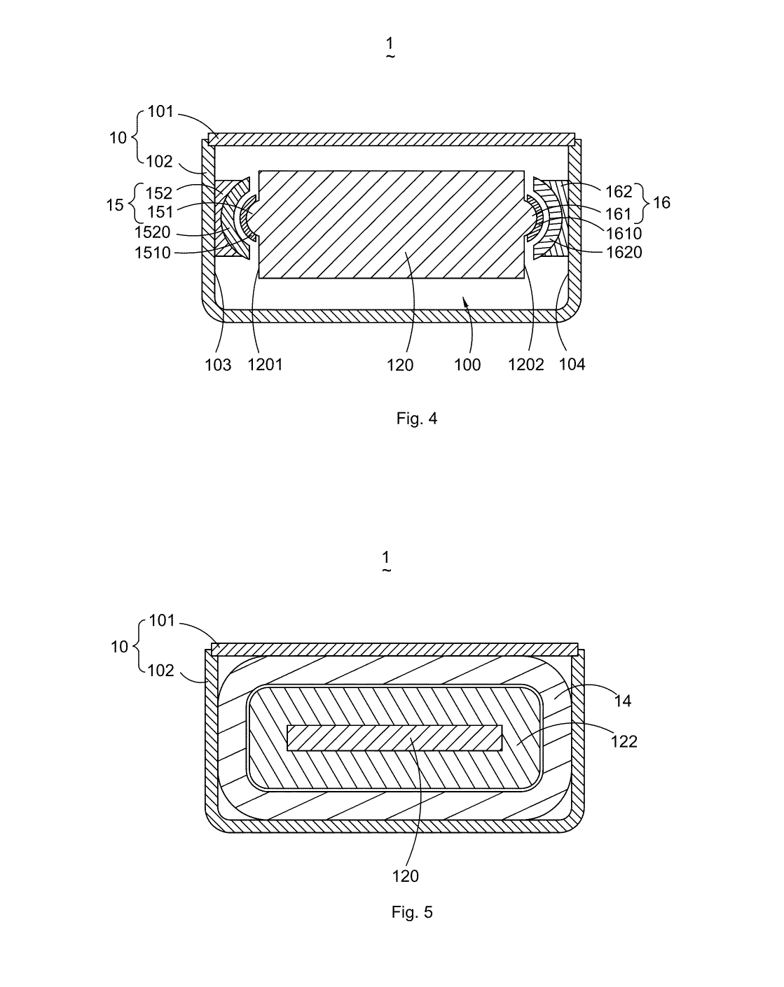

Referring also to FIG. 4, the vibration motor 1 further includes a ring driving coil 14 provided circularly in a periphery of the vibrator unit 12 for driving the vibrator unit 12 to vibrate repeatedly along a vibration direction X-X. The vibration motor 1 includes engaging assemblies 15, 16 provided between the vibrator unit 12 and the housing 10 for suspending the vibrator unit inside the housing 10 to make the vibrator unit 12 to move along the vibration direction X-X.

The vibrator unit 12 includes a long-strip clump weight 120, a third magnet 121, a driving magnet 122 and a fourth magnet 123 fixed in the clump weight 120. The third magnet 121 is such configured that a magnetic pole thereof is similar to an adjacent magnetic pole of the first magnet. The fourth magnet 123 is such configured that a magnetic pole thereof is similar to an adjacent magnetic pole of the second magnet 13. By utilizing the repelling force generated between the first magnet 11 and the third magnet 121 and the repelling force generated between the second magnet 13 and the fourth magnet 123, the first magnet 11 and the second magnet 13 can limit the displacement of the vibrator unit 12 on the vibration direction X-X of the vibrator unit and provide restoring force to the vibrator unit 12.

The clump weight 120 provides slots 1203 along two ends of the vibrator unit 12 along the vibration direction X-X. The third magnet 121 and the fourth magnet 123 are fixed respectively in slots 1203. The clump weight 120 corresponds the driving magnet 122 and depresses and forms one bearing part 1204 and a ring groove 1205 encircling the bearing part 1204. The driving magnet 122 sheathed and fixed in the bearing part 1204 and received in the ring groove 1205. In this way, the outside surface of the driving magnet 122 will not exceed the outer surface of the clump weight 120.

The clump weight 120 includes a first outer side face 1201 and a second outer side face 1202 extending along the vibration direction X-X of the vibrator unit 12. Optionally, the first outer side face 1201 is parallel to the second outer side face 1202. The housing includes a first inner side face 103 and a second inner side face 104 extending along the direction of vibration X-X of vibrator unit. Similarly, the first inner side face 103 and the second inner side face 104 are set mutually parallel in the embodiment. The engaging assemblies 15 and 16 include a first engaging assembly 15 located between the first outer side face 1201 and the first inner side face 103 and a second engaging assembly 16 located between the second side face 1202 and the second inner side face 104.

Referring to FIG. 4, the first engaging assembly 15 includes a first guide rail part 151 fixed in the first outer side face 1201 provided with a first guide rail 1510, and a first guide groove part 152 fixed in the first inner side face 103 and cooperating with the first guide rail part 151 for forming a first guide groove 1520. The second engaging assembly 16 includes a second guide rail part 161 fixed on the second outer side face 1202 provided with a second guide rail 1610, and a second guide groove part 162 fixed in the second inner side face 104 which cooperates with the second guide rail part 161 to set a second guide groove 1620.

By virtue of the cooperation between the first and second guide rails 1510 and 1610 and the first and second guide grooves 1520 and 1620, the vibrator unit 12 is suspended in the housing 10 and moveable along the vibration direction X-X.

In this embodiment, the first and the second guide rails 1510 and 1610 are magnetic guide rails. The first and second guide groove 1520 and 1620 are magnetic guide groove. The first and second guide groove 1520 and 1620 are respectively sheathed and set at outer side of the first and second guide rails 1510 and 1610. Moreover, the first and the second guide rails 1510 and 1610 are respectively set with the first and the second guide groove 1520 and 1620 as per opposite homopolarity. The settings above make the first and second guide rails 1510 and 1610 magnetically suspend inside the first and second guide groove 1520 and 1620. Circular-arc guide rails is adopted preferably for the first and second guide rails 1510 and 1610. The first and second guide groove 1520 and 1620 present the circular-arc guide groove that matches the first and the second guide rails 1510 and 1610.

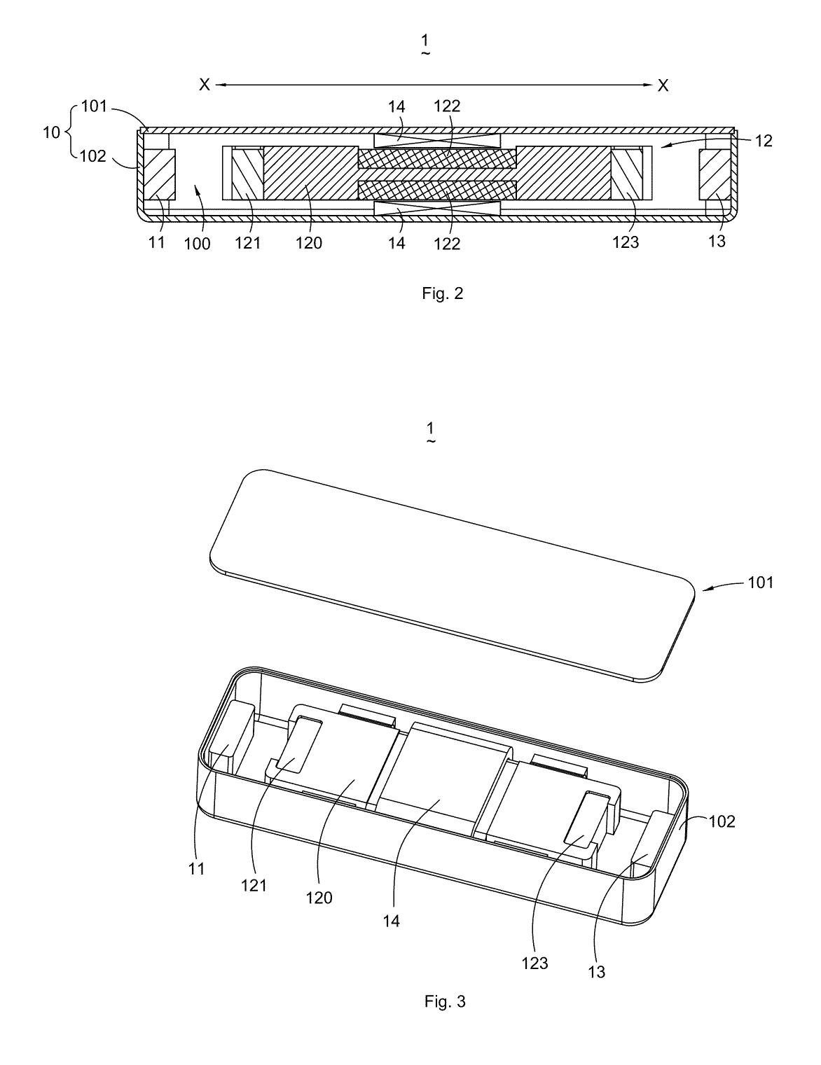

Referring to FIGS. 2 and 5, the driving magnet 122 is a ring magnet. The ring driving coil 14 matches the shape of the ring driving magnet 122. Optionally, radial magnetization is adopted for the driving magnet 122, After being powered on, the driving coil 14 in the magnetic field driven by the driven magnet 122 is affected by the action of Ampere force. After the driving magnet 122 is affected by the counter force of Ampere force, the vibrator unit 12 is promoted to vibrate repeatedly along the vibration direction X-X. The driving magnet 122 is not limited to the ring magnet. It can be divided into four pieces of magnets affixed in periphery of the clump weight 120 respectively to reach the same effect as the ring magnet does. Use the inventive concept of the invention and the protection scope required by the invention.

The flat linear vibration motor 1 provided by the invention utilizes the restoring force provided by the repelling force between magnet and utilizes prismatic pair to provide localization guidance for vibrator of unit 12 and set the driving coil 14 as ring and set circularly in periphery of driven magnet 122 to improve the utilization of magnet to avoid the effect on performance of motor and service life due to the failure or wear of spring parts of traditional vibration motor to promote the performance of vibration motor 1 efficiently.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flat linear vibration motor, including:
a housing having an accommodation space;
a first magnet received in the accommodation space and fixed in the housing;
a vibrator unit suspended in the housing, the vibrator unit including a clump weight, a third magnet, a driving magnet, and a fourth magnet, the third magnet being such configured that a magnetic pole thereof is samilar to an adjacent magnetic pole of the first magnet;
a second magnet fixed in the housing, the first magnet, the vibrator unit and the second magnet arranged one by one along a vibration direction of the vibrator unit; the second magnet being such configured that a magnetic pole thereof is samilar to an adjacent magnetic pole of the fourth magnet;
engaging assemblies suspending the vibrator unit inside the housing and enabling the vibrator unit to move along the vibration direction; wherein the flat linear vibration motor further includes a ring driving coil received in the accommodation space, the ring driving coil being spaced from and surrounding the driving magnet.

2. The flat linear vibration motor as described in claim 1, wherein the housing includes an upper shell and a lower shell cooperating with the upper shell for forming the accommodation space, the lower shell includes a bottom wall and a side wall extending from the bottom wall, the first magnet and the second magnet are fixed respectively on the side wall of the lower shell.

3. The flat linear vibration motor as described in claim 1, wherein the clump weight includes a first outer side face and a second outer side face opposed to the first outer side face, the housing includes a first inner side wall and a second inner side wall, the engaging assemblies includes a first engaging assembly located between the first outer side face and the first inner side face, and a second engaging assembly located between the second outer side face and the second inner side face.

4. The flat linear vibration motor as described in claim 3, wherein the first outer side face and the second outer side face extend along the vibration direction of the vibrator unit, the first inner side wall and the second inner side wall extend along the vibration direction of the vibrator unit.

5. The flat linear vibration motor as described in claim 3, wherein:
the first engaging assembly includes a first guide rail part fixed on the first outer side face and forming a first guide rail, and a first guide groove part fixed on the first inner side surface and forming a first guide groove, the first guide rail part being cooperating with the first guide groove part;
the second engaging assembly includes a second guide rail part fixed on the second outer side face and forming a second guide rail, and a second guide groove part fixed on the second inner side surface and forming a second guide groove, the first guide rail part being cooperating with the first guide groove part; and
by virtue of the cooperation between the guide rails and the guide grooves, the vibrator unit is suspended in the housing and moveable along the vibration direction.

6. The flat linear vibration motor as described in claim 5, wherein the first and second guide rails are made of magnetic rails, the first and second guide grooves are magnetic grooves, the first and second guide grooves respectively wrap the first and second guide rails, further, the same magnetic poles of the first guide rail and the first guide groove are configured to face to face, the same magnetic poles of the second guide rail and the second guide groove are configured to face to face, such that the first and second guide rails are suspended respectively in the first and second guide grooves.

7. The flat linear vibration motor as described in claim 1, wherein the clump weight forms two slots at two ends thereof along the vibration direction, the third magnet and the fourth magnet are fixed inside the slots.

8. The flat linear vibration motor as described in claim 1, wherein the driving magnet is a ring magnet, a bearing part is formed at a position corresponding to the driving magnet and a depress surrounding the bearing part, the driving magnet engages with the bearing part and is received in the depress.
